(19) United States
(12) Patent Application Publication
(10) Pub. No.: US 2013/0073432 A1
(43) Pub. Date: Mar. 21, 2013

(54) SHOPPING AND/OR PERFORMING FINANCIAL TRANSACTIONS USING A SMARTPHONE

(71) Applicant: Albert MULHOLLAND, Auckland (NZ)

(72) Inventor: Albert MULHOLLAND, Auckland (NZ)

(21) Appl. No.: 13/595,957

(22) Filed: Aug. 27, 2012

(30) Foreign Application Priority Data
Aug. 26, 2011 (AU) 2011213908

(51) Int. Cl. G06Q 20/40

(52) U.S. Cl. CPC G06Q 20/40; G06Q 30/0623
USPC 705/26.61

(57) ABSTRACT

An authenticated user is enabled to purchase a product or information using a registered mobile device, and including in examples described using only a registered mobile device. A mobile device can be assigned a derived unique identifier associated with the user's phone number. Product identifying information can be received, for example from a product information server, and product information is displayed to the user. An indication may be received from the user that product/information is desired to be purchased, and payment is arranged to be transferred to a vendor associated with the product using credits or other payment methods, including for example pre-purchased credits. For example, payment can be arranged in part by dedicating the user with an authentication server using authentication information, for example a device identifier encoded in or with the mobile device.

### FIELD OF INVENTION

The present invention relates to methods and systems for empowering a consumer in purchasing products and/or obtaining consumer information relating to the products and their supply chains, and/or performing financial transactions, and in particular, to methods and systems for purchasing products and/or obtaining consumer information and/or transferring funds and/or remitting, internationally and domestically, by an authenticated user using only the user's automatically authenticated smartphone.

### BACKGROUND

With the widespread acceptance and use of online shopping as a credible and even preferred alternative to traditional retailing, the number and variety of methods and systems to support and enhance shopping and payment continues to increase. A typical online shopper may use a variety of distinct systems, to cover each step of the shopping experience. For example, the user may first search a large retailer or distributor to decide on a product they wish to purchase; then visit a price comparison website to find a vendor offering the product at a low price, and finally visit that vendor's website or store to purchase the product. In some cases, the user may also visit a further website, such as a bank, to transfer funds to the vendor. By requiring multiple steps, the typical online shopping process is effort-intensive.

Further, the remitting of funds may require both parties to have a bank account, and the use of a third party such as a bank to arrange transfer. Even where a bank account is not required, users may be required to use a third party to effect the transfer, which may be inconvenient or insecure, particularly when the transfer is done internationally.

Some systems may use or propose an Internet-capable smartphone for on-line or in-store shopping or for financial transactions, however typically such systems are not independent of the stores or financial institutions involved in the transactions, are intended to encourage the consumer to spend or transact more only with those stores or institutions, and will not provide the consumer with negative information.

Further, existing or proposed integrated shopping or remitting methods and systems using smartphones may require the person making a payment to input their mobile phone number into a terminal to initiate a payment authorisation request, to then receive an SMS authorisation request on their smartphone, and then to SMS reply to the authorisation request from their smartphone, to make payment. This is both effort-intensive and costly, as the payer would normally pay for all the SMS traffic required to request authorisation and to authorise a payment. This type of arrangement is described in US 2010/0216425.

Further, existing or proposed integrated shopping or remitting methods and systems using smartphones are reliant on existing and costly payment methods such as credit cards, debit cards, and transfers between bank accounts to effect payments.

Accordingly, existing systems and methods do not provide a customer-empowering and cost-minimising, streamlined and integrated experience that automatically provides a secure end-to-end shopping experience and/or funds transfer and/or remitting experience.

### OBJECT OF INVENTION

It is an object of the invention to overcome or ameliorate one or more of the disadvantages of the prior art, or to at least provide the public with a useful choice.

### STATEMENTS OF INVENTION

In a first aspect, there is provided a method for enabling an authenticated user to purchase a product and/or obtain consumer information relating to the product and its supply chain using only an authenticated mobile device, the mobile device having a phone number of the authenticated user associated therewith, the method including:
receiving identification information for a product;
sending at least part of the identification information to a product information server;
receiving product information about the product from the product information server, such information costing pre-purchased credits or being free to the user, depending on the information;
displaying the product information to the user;
receiving an indication from the user that they wish to purchase the product; and
arranging for payment to be transferred to a vendor associated with the product, using pre-purchased credits, the arranging for payment including:
   authenticating the user with an authentication server by transmitting
   authentication information to the authentication server, the authentication information including at least a device identifier of or associated with the mobile device.

In this and other aspects of the invention, the device identifier may be unique or near unique and encoded in or with the mobile device, either within circuitry integral thereto or within a removable module such as a SIM card. Those skilled in the art will be aware of unique device identifiers and any such identifier may be used within the scope of the invention. The key required functionality is that the identifier is able to uniquely identify a particular device, and therefore associated user, as performing particular steps described herein, such as performing a transaction. Additionally or alternatively a phone number associated with the mobile device may be used to distinguish the device and therefore the user thereof. Further as used herein, the device identifier may include only a part of a particular device identifier or parts of a plurality of device identifiers which together distinguish a device (and user) from other devices (and users). Further, where consumer information is provided free of charge, authentication steps may still be performed but no payment being transferred or a zero payment transferred such that only authenticated users/devices are able to obtain said information.

In a second aspect, there is provided a method of authenticating a user of a mobile device used during purchasing, the method including:
receiving authentication information from a mobile device, the authentication information including at least a unique device identifier of or associated with the mobile device and security information;
retrieving a user profile from an authentication database, the user profile corresponding to the phone number;
verifying the security information against the user profile;
notifying the mobile device of whether authentication was successful and/or unsuccessful.

In a third aspect, there is provided a method of remitting pre-paid purchasing credits internationally and/or domestically between a remitter account linked to a mobile device of a remitter in one country and a recipient account linked to a mobile device of a recipient in another country or in the same country, the authenticated remitter using only the registered mobile device of the remitter and the authenticated recipient using only the registered device of the recipient, the method including:
receiving recipient identification information and an indication of an amount of funds from the remitter; arranging for the sum to be transferred from the remitter account to the recipient account;
wherein the arranging includes:
   authenticating the remitter with an authentication server by transmitting authentication information to the authentication server, the authentication information including at least a unique device identifier of or associated with the mobile device, and security information.

In a further aspect, there is provided a system for enabling an authenticated user to purchase a product using an authenticated mobile device, the mobile device having a phone number associated therewith, the system including:
a receiver for receiving identification information for a product;
a transmitter for sending at least part of the identification information to a product information server;
a receiver, preferably the same receiver, for receiving product information about the product from the product information server;
a display for displaying the product information to the user;
a receiver, preferably the same receiver, for receiving an indication from the user that they wish to purchase the product;
a payment module for arranging for payment to be transferred to a vendor associated with the product; and
an authentication module for authenticating the user with an authentication server by transmitting authentication information to the authentication server, the authentication information including at least a unique device identifier of or associated with the mobile device, and security information.

In a further aspect, there is provided a system for authenticating a user of a mobile device used during purchasing, the system including:
a receiver for receiving authentication information from a mobile device, the authentication information including at least a unique device identifier of or associated with the mobile device and security information;
a retrieval module for retrieving a user profile from an authentication database, the user profile corresponding to the phone number;
a verification module for verifying the security information against the user profile;
a notification module for notifying the mobile device of whether authentication was successful and/or unsuccessful.

In a further aspect, there is provided a system for remitting pre-purchased credits internationally and/or domestically using mobile phones between a remitter account linked to an authenticated mobile phone of an authenticated remitter in one country and a recipient account linked to an authenticated mobile phone of an authenticated recipient in another country or in the same country, the system including:
a receiver for receiving recipient identification information and an indication of an amount of funds from the remitter;
a processor for arranging for the sum to be transferred from the remitter account to the recipient account;
an authentication module for authenticating the remitter with an authentication server by transmitting authentication information to the authentication server, the authentication information including at least a unique device identifier of or associated with the mobile phone, and security information.

Further aspects provide a computer program or computer program product which, when executed on suitable enabled device(s), causes or enables any one of the above methods to be performed.

More particularly, in a further aspect, there is provided a computer program for performing a method for enabling a user to purchase a product and/or obtain consumer information related to the product and its supply chain, using an authenticated mobile device, the mobile device having a phone number associated therewith, the method including:
receiving identification information for a product;
sending at least part of the identification information to a product information server;
receiving product information about the product from the product information server, such information costing pre-purchased credits or being free to the user, depending on the information;
displaying the product information to the user;
receiving an indication from the user that they wish to purchase the product; and
arranging for payment to be transferred to a vendor associated with the product, the arranging for payment including:
   authenticating the user with an authentication server by transmitting authentication information to the authentication server, the authentication information including at least a unique device identifier of or associated with the mobile device.

In a further aspect, there is provided a computer program for a method of authenticating a user of a mobile device used during purchasing, the method including:
receiving authentication information from a mobile device, the authentication information including at least a unique device identifier of or associated with the mobile device, and security information;
retrieving a user profile from an authentication database, the user profile corresponding to the phone number;
verifying the security information against the user profile;
notifying the mobile device of whether authentication was successful and/or unsuccessful.

In a further aspect, there is provided a computer program for performing a method of remitting pre-paid purchasing credits internationally and/or domestically between a remitter account linked to an authenticated mobile device of an authenticated remitter in one country and an authenticated recipient account linked to an authenticated mobile device of a recipient in another country or in the same country, the method including:
receiving recipient identification information and an indication of an amount of funds from the remitter;
arranging for the sum to be transferred from the remitter account to the recipient account;
wherein the arranging includes:
   authenticating the remitter with an authentication server by transmitting authentication information to the authentication server, the authentication information including at least a unique device identifier of or associated with the mobile device, and security information.

Preferred embodiments are set out in the dependent claims.

Further preferred embodiments relate to systems adapted to implement one or more of the methods as set out in the dependent claims, and computer programs adapted to perform one or more of the methods as set out in the dependent claims.

This invention may also be said to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF FIGURES

Preferred forms of the present invention will now be described with reference to the accompanying drawings in which;

FIG. 1 shows a flowchart of a user purchasing a product using a mobile phone;

FIG. 2 shows an example system for enabling the method shown in FIG. 1;

FIG. 3 shows a flowchart of an authentication method;

FIG. 4 shows a flowchart of a product and vendor identification method;

FIG. 5 shows a flowchart of an order processing and payment method;

FIG. 6 shows a flowchart of a remittance method.

### DETAILED DESCRIPTION

As used herein, the term “phone number” is used to refer to a conventional phone number used for dialling, but is preferably for a mobile handset, and preferably includes a country code.

The term “smartphone” is used herein as commonly understood to mean a device having an associated phone number and that is web-enabled. As will be apparent to those skilled in the art, such devices have unique device identifiers encoded therein and/or associated therewith (e.g. via a SIM card). Where used herein, “mobile device” will preferably be in the form of a smart phone.

Where a database is referred to, it should be appreciated that this does not necessarily require a single database to be used. For example, the information may be spread across several linked databases, yet still fall within “database” as used herein. Alternatively, “database” as used herein may be a single table within a larger database.

More generally, those skilled in the art will appreciate that hardware used to implement the invention may be distributed or concentrated as desired without invention based on system requirements and/or administrator preferences, with known communication means used to relay data between different elements, if required. For example, the servers, processors and other elements may be concentrated largely into a single said device or separate (either co-located or geographically dispersed) as desired and depending on system limitations and requirements.

### Purchasing

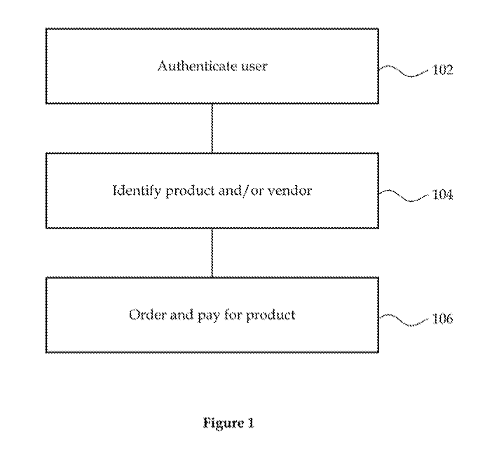

FIG. 1 shows a method for a registered user to purchase products using their registered mobile phone.

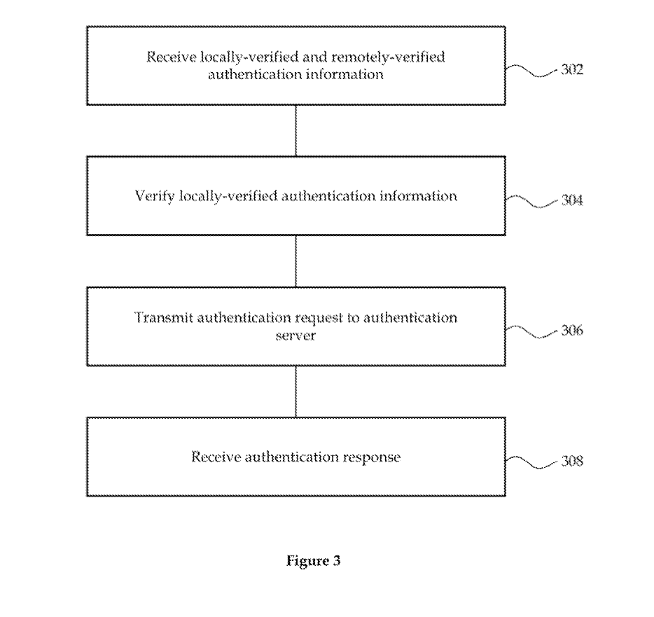

At step 102, the user is authenticated. This is done to reduce the risk of fraudulent or unauthorised transactions, and is described in more detail below in relation to FIG. 3. Note this step may be performed later in the sequence but must be performed prior to actual purchase.

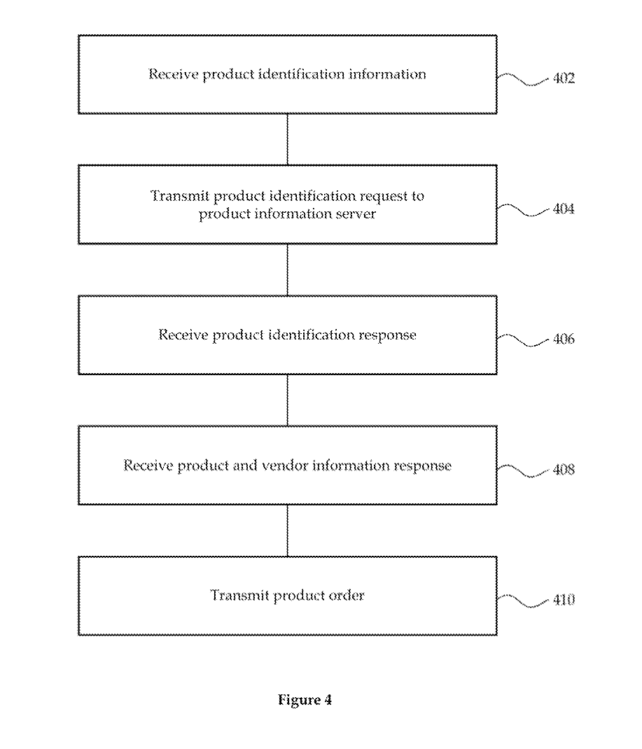

At step 104, the mobile phone is used to identify a product which the user is interested in. This is described in more detail below in relation to FIG. 4.

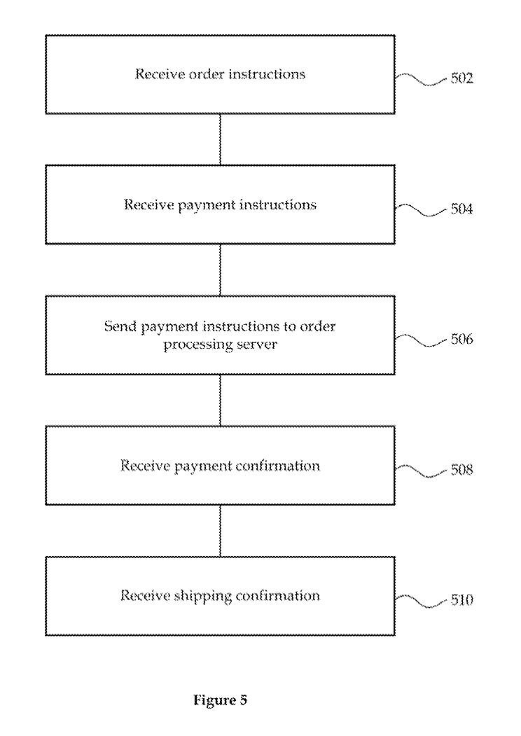

At step 106, an order is sent for the product using the mobile phone. This is described in more detail below in relation to FIG. 5. It will be appreciated by those skilled in the art that multiple products may be ordered simultaneously.

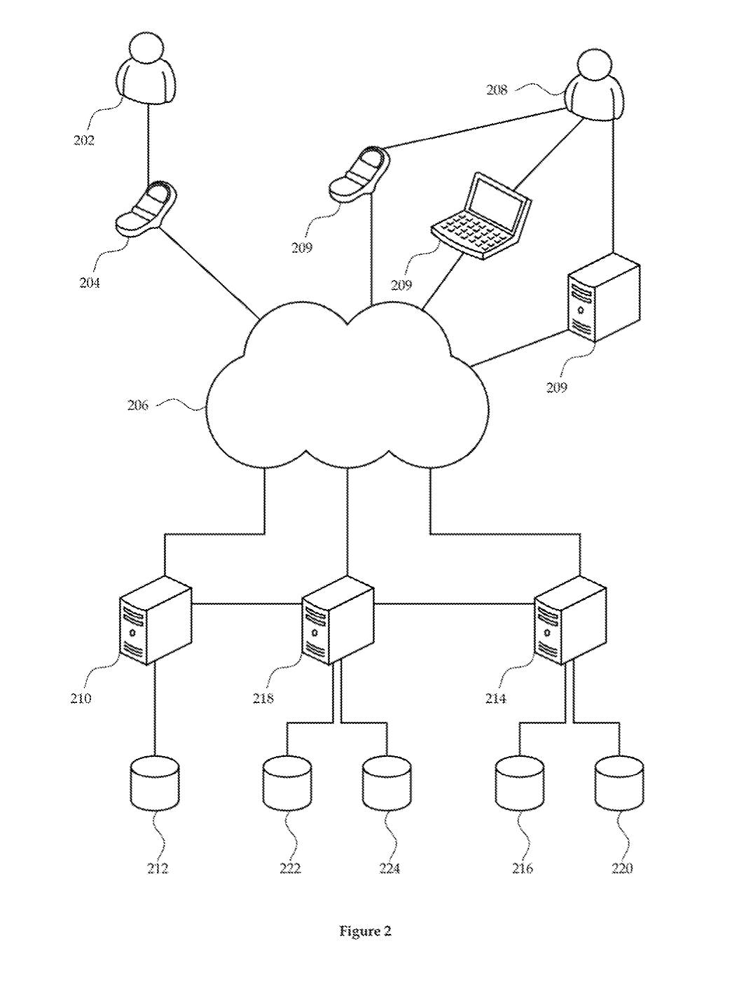

FIG. 2 shows an example system architecture in which the mobile phone can operate to implement the method shown in FIG. 1.

User 202 gives instructions to user terminal 204, preferably a mobile device such as a mobile phone. Typically this will be through using appropriate input means associated with the phone, such as a keypad, keyboard, camera, scanner, touch-screen or buttons. It will be appreciated that voice control or the like may also be used, and likewise it is conceivable for the mobile phone to be remotely controlled through another device.

User 202 can on different occasions and in the different embodiments of the system be a purchaser of goods and/or information, a remitter of funds, or a recipient of funds.

The user terminal may be any appropriate device having or associated with one or more unique identifiers which can communicate across a cellular network, and as such, is not limited to conventional mobile phones or smart phones. For example, the user terminal may be a laptop or a tablet provided with a SIM card to enable communication over a cellular network.

The mobile phone is connected to a network 206. Network 206 may typically include a conventional cellular network capable of communicating with data networks such as the Internet, but could for example, be a restricted network for use by only a particular group of people or within a limited area.

Vendor 208 is similarly connected to network 206 via one or more devices 209 (for example a mobile phone, a personal computer, or a server). It will be appreciated that there will often be a plurality of vendors connected to network 206, however for simplicity, only a single vendor is shown. Similarly, there may be multiple users 202 and respective user terminals 204. The vendor will typically be connected through a server or the like adapted to receive and respond to queries and requests from purchasers automatically, rather than requiring a manual response. However, in some cases the vendor's server may require a person to manually approve each order before it is finalised. Systems for receiving and responding to queries and requests from purchasers automatically are known in the art, and may be selected by a skilled person, based on system requirements and/or preferences.

An authentication server 210 is connected to network 206 and to authentication database 212. Authentication database 212 may include user details, such as a mobile phone number and/or security information. The mobile phone number may be required to be unique within the database. The security information may include a pin, a password or the like.

The contents of authentication database 212 relating to a user may be supplied by that user when they register to use the system and/or may be supplied by the system itself (for example, by querying the mobile phone directly). The contents may include one or more phone numbers associated with the mobile phone preferably including country code and/or one or more unique or near unique device identifiers of the mobile device.

One advantage of querying the mobile phone directly, rather than relying on user input, is that this can reduce a first user impersonating a second user, by supplying the second user's mobile phone number or the like. Further, retaining multiple identifiers for a device may assist in verifying that the user terminal is not subsequently being mimicked by another device.

In some embodiments, authentication database 212 may be linked to or part of a user database and/or a vendor database (which in turn may be the same database).

The user database may include details such as: name; address; e-mail; other contact information; username and password for viewing the user's account details.

The vendor database may including details such as: vendor name; vendor address; vendor e-mail; other vendor contact information; username and password for accessing vendor's account; vendor account number; names and contact details of vendor contact people; location preferably expressed as location coordinates; the territory of the vendor preferably expressed as a set of boundary-defining coordinates. By accessing the vendor's account through a suitable website or the like, the vendor may be able to view and/or update any of their details. The vendor may also be able to view and/or update inventory information, including stock levels and prices. Note that stock levels, for example, may be automatically updated as sales are registered. Known inventory solutions may be used to this end.

Preferably, the purchaser and/or the vendor are able to view pending or historical transactions, as desired, by querying the relevant databases after successful authentication.

A product information server 214 is connected to network 206, to product information database 216 and to sales and inventory database 220. The product information database 216 may include information about various products, such as: a barcode number or other identifier or tag of the product which is preferably unique in the database; a brand name; a brand owner; a prime producer or manufacturer; details of entities contributing to the production and supply of the product; country or countries of origin; product images or video clips; description; features; colour; size; voltage; packaged dimensions; weight; ingredients; specification; nutritional information; socio or eco labels given to the product; standard compliance labels given to the product; ratings or reviews of the product by third parties; a cumulative rating of the product given by users.

Typically, the contents of product information database 216 are supplied by brand owners or individual vendors and/or by consumer and standards agencies when they register to form part of the system, and may be continually updated by the same entities. Further contents may be provided by registered users when they use the system. However, it will be appreciated that some or all of this information may be obtained through other means, such as scraping the information from publicly accessible websites.

The sales and inventory database 220 may be linked to product information database 216 and may include information about each product, such as: the barcode number or other identifier or tag of the product; a list of vendors for the product; the cumulative vendor rating of each vendor by users; the location of each vendor preferably expressed as location coordinates; the territory of each vendor preferably expressed as a set of boundary-defining coordinates; a number of the product in stock at each vendor at a date and time (local to the user and/or to the vendor and/or GMT); delivery cost and time to delivery for each vendor; and/or price information for the product at each vendor. The price information may include a price excluding tax, and/or a price including any applicable tax. When the vendor is located in a different country to the user, the prices may be shown in the local currency of the user. Alternatively or additionally, some information such as prices or delivery costs may be computed dynamically at the time of purchase, in the currency of the user and/or the vendor, and so may not be present in sales and inventory database 220 for some products and/or vendors.

Typically, the contents of the sales and inventory database 220 will be supplied and maintained by registered vendors, and by registered users as they use the mobile purchasing system of the present invention.

An order processing and payment server 218 is connected to network 206, user accounts database 222 and vendor accounts database 224.

User accounts database 222 may include information about user transactions such as, for each user transaction: a unique preferably system-generated transaction number; a user account number which may be the user's mobile phone number preferably including country code; a time and date of the order for the transaction (local to the user and/or to the vendor and/or GMT); a time and date of the vendor fulfilment and shipping confirmation for the transaction (local to the user and/or to the vendor and/or GMT); location coordinates of the user at the time of transaction provided from the user's mobile phone by the mobile phone application of the invention; a type of user transaction. Where the transaction is a product purchase: the user transactions information may include one or more of: a unique code of the product purchased; description of the product; quantity of the product purchased; price per unit of the product purchased; same details for any other products purchased from the same vendor in the same transaction; total price paid; the currency paid in; estimated taxes payable by the user in the currency of the user if not included in the total price paid; estimated delivery date; delivery address; delivery entity; delivery entity contact phone number in user's country; delivery reference number; the account number of the vendor; the name of the vendor; contact phone number and e-mail address of the vendor; payment method used; a balance of credits in the user's account after the transaction. More particularly, the letter may refer to a balance of “credits” of the invention which are termed herein “Mobile Purchasing Credits” or “MPCs”.

Payment methods supported by the invention may include user credit cards, online bank transfers, as well as MPC transfers.

Apart from product purchases by the user, other user transaction types using the mobile phone of the user linked to the user account may include funding of the account through the purchase of MPCs, the remitting of MPCs to another user, or the cashing in of MPCs by arranging a bank transfer to the user's nominated bank account or to a third party bank account.

Vendor accounts database 224 may include information about users' transactions with any vendor, such as, for each user/purchaser transaction, one or more of: the unique account number of the vendor, the name of the vendor, the unique system-generated user transaction number, the purchaser name and address, the time and date of the order for the transaction in GMT and/or vendor time, the time and date of the vendor fulfilment and shipping confirmation for the transaction in GMT and/or vendor time, the unique code of the product purchased, the description of the product, the quantity of the product purchased, the price per unit of the product purchased, the same details for any other products purchased from the vendor in the same transaction, the amount of freight payable by the vendor, the total price received by the vendor inclusive of taxes and freight payable by the vendor, the currency received by the vendor, estimated delivery date, delivery address, delivery entity, delivery entity contact phone number in vendor's country, delivery reference number, the payment method used by the user/purchaser, the commission charged to the vendor (preferably in MPCs) and the cumulative balance in the vendor's account after the transaction (preferably in MPCs).

In addition there may be further databases connected to network 206 which may be internal or external to the system. Such further databases may be accessed to enable the system to calculate and report to the mobile phone of the user, at any transaction time, the delivery time lag, and the product price in the currency of the user, inclusive of freight, taxes and commissions.

In some embodiments, each of these may be administered by the same operator, however this is not essential. Further, any of authentication server 210, authentication database 212, product information server 214, product information database 216, sales and inventory database 220, order processing and payment server 218, user accounts database 222, vendor accounts database 224, and/or any further databases may be co-located, integrated and/or dispersed as required based on system requirements and/or preferences. This applies equally to other elements of the system.

### Authentication

FIG. 3 shows a preferred method performed to authenticate a user.

At step 302, a mobile phone receives authentication information from a user. In some embodiments, this may include two types of authentication information: locally-verified authentication information (LVAI) and remotely-verified authentication information (RVAI). LVAI may be biometric data of some kind, such as a fingerprint, palm print, hand geometry, iris recognition, retina recognition or face recognition.

By having biometric data stored locally, there is no need for personal biometric data to be stored on a remote server. As some consumers are averse to storing personal information on a remote server, particularly where that personal information is biometric, this may be seen as an advantage.

The RVAI may include a PIN, which may be easily entered using a conventional mobile phone keypad. A typical alphanumeric password or the like may also be used.

The RVAI may additionally or alternatively include a mobile phone number associated with the mobile phone and/or one or more other unique device identifiers stored on a SIM card. Other “device” identifiers may additionally or alternatively be used such as an IMEI number (International Mobile Equipment Identity number), ESN (Electronic Serial Number), MEID (Mobile Equipment Identifier), IMSI (International Mobile Subscriber Identity) or MAC address (Media Access Control address). Each unique device identifier need not be user-entered or necessarily visible or known to the user, but instead may be extracted by the system.

LVAI may be in a similar form to RVAI but verified locally to obtain the attendant advantages of the dual verification process.

In some embodiments, authentication information that is user-entered may be entered when the user wishes to proceed with the purchasing. However, it is feasible to store part of the authentication information (particularly RVAI) on the mobile phone, so that a user need not enter it each time, based on user preferences, although for security purposes some form of user input, even if limited, is preferred.

At step 304, LVAI is verified. Methods for verifying biometric data are known in the art, and an appropriate such method may be selected by those skilled in the art. Broadly, the LVAI is compared with locally-stored reference authentication information, the authentication being successful if the LVAI and the reference information are sufficiently similar.

Note that data for RVAI purposes is preferably not provided by a user until the LVAI is verified.

At step 306, an authentication request is transmitted to an authentication server. The authentication request includes at least all or some or parts of the automatically extractable device identifiers encoded in or with the mobile device and, when extractable, may include a phone number associated with the mobile device and the user-entered part of the RVAI. In some embodiments, the authentication request, or at least the RVAI, is sent encoded or encrypted, such as using public-key cryptography or another suitable encoding method. This is to reduce the risk that a third-party can see the RVAI through a “man-in-the-middle attack” or the like. However, this may not be necessary when the network is “trusted”.

Assuming the authentication request is received by the authentication server, it is processed (as described below). The authentication server then transmits an authentication response to the mobile phone, confirming whether the authentication was successful or not. If the authentication was successful the authentication response need not be visible to the user.

At step 308, the mobile phone receives the authentication response. If the authentication response is unsuccessful, the mobile phone may prompt the user to re-input the RVAI and/or the LVAI, may prevent further access for a pre-determined amount of time, or trigger other authentication procedures known in the art. For example, the user may be prompted to telephone a customer service centre.

If the authentication response is successful, the mobile phone can proceed to the product and vendor identification stage.

### Identifying a Product and Vendor

Referring now to FIG. 4, there is shown a preferred method for identifying a product and vendor.

At step 402, the mobile phone receives product identification information (PII).

In some embodiments, the mobile phone actively retrieves the PII, such as by reading a barcode, a QR code, an RFID tag or the like. The mobile phone may include some image recognition means to allow the packaging of the item to be recognised. In other embodiments, the PII may be manually entered by the user. Some combination of these may also be used.

The PII preferably includes a unique code or near-unique code (such as in the case of barcodes), and/or may include practically any information that could be used to identify the product, including the name of the product, the brand, the name of the manufacturer, model number, size, colour or quantity.

At step 404, after receiving the PII, the mobile phone sends a product identification request to a product information server.

The product identification request is processed by the product information server (as described below), which transmits a product identification response.

At step 406, the mobile phone receives the product identification response, preferably identifying one or more products fitting the PII. If the product identification response identifies no products, the mobile phone may notify the user and invite the user to input additional details before restarting at step 402, (or to exit the system and be redirected to a predetermined screen, such as a search engine response or the like) for the PII entered. If the PII does not relate to the product wanted by the user, the user may be able to indicate this, and the process may restart at step 402 or 404.

In some embodiments, only products which meet certain criteria may be displayed. For example, only products in-stock with at least one vendor may be included in the product identification response.

For each product identified in the product identification response, the response may include objective product information and/or subjective product information. The objective product information received by the mobile phone for each candidate product in the product identification response may include one or more of: brand, description, model, colour, size, voltage, links to one or more images and/or video clips, product ingredients, product nutritional values, product specification, country or countries of origin, brand owner, brand producer, contributors to the product's supply chain information. The subjective product information may include one or more of: summary or aggregated ratings for the product by users of the system, eco or social labels given to the product/producer/supply chain, standards compliance labels given to the product/producer/supply chain, and consumer agency ratings or reviews for the product/producer/supply chain.

In some embodiments, only some of the product information may be initially presented to the user. The user may then be able to request further product information to be presented.

In some embodiments, some product information will cost the user MPCs. Registered information providers such as consumer agencies may for example charge a pre-defined number of MPCs to the systems operator per information delivery. The systems operator may in turn add a margin and charge the user a margin-inclusive number of MPCs each time the consumer labels of a consumer agency are displayed to the user in response to a product information request from the user. Users could be advised of the cost to them of an information request and have the option of cancelling the request.

In some embodiments, users can pre-define their product information preferences so that they do not need to re-enter them at each shopping transaction. For example a user may be interested in consumer ratings from only one particular rating agency and could set their user profile up accordingly, so that only the ratings or labels assigned by that agency to a product would be displayed and charged to the user.

In some embodiments, the user may be alerted by the product identification response on the mobile phone if the product is known by the system to meet or not meet user-defined criteria. Examples of such user-defined criteria could include and are not limited to: “Gluten?”, “Palm Oil?”, “Certified Halal?”, “Tested on Animals?”, “Child labour?”, “Weapons manufacture by any corporation party to the supply of the product?”. The alert given by the mobile phone may be an audio alert, a visual alert, or both. From the products identified in the product identification response, the user selects their desired product, or enters additional or changed details before restarting at step 402. For example, if the user bases their search on a red widget of size 8, but wants a blue widget of size 10, they may input details of the red widget (for example, by scanning a barcode) and change the colour to blue and the size to 10.

At step 408, the mobile phone receives the product and vendor information response, preferably identifying a number of vendors. The default response, which may be reset at any time by the user, may rank the vendors by proximity to the user from closest to furthest, within a radius of x kilometres or miles from the user, where x defaults to a distance set up at user registration, but where x may be increased or decreased as required by the user. Alternatively, the user may select the option to view the vendors within the user-defined radius from the user, ranked by pick-up price, from cheapest to dearest. If a large number of vendors are identified, the mobile phone may limit the display to a pre-determined or user-selected number.

In some embodiments the user may set the location of the centre of the search circle. The centre would normally default to the location coordinates of the mobile phone as determined by the mobile phone or the underlying network. However, the user could have the option of entering the coordinates of a different location, for example of a future travel destination.

In other embodiments the user may identify all vendors that have the product in-stock in their country and receive those vendors ranked by delivered price, cheapest to dearest. The user may also identify all vendors that have the product in-stock globally and receive those vendors ranked by delivered price, possibly in the currency of the user, cheapest to dearest.

For each vendor identified in the product and vendor information response, the response may include vendor and supply information.

The vendor and supply information may include one or more of: distance of vendor in kilometres or miles from the user, a per-unit pick-up price including any applicable taxes, a per-unit delivered price including any applicable taxes, delivery costs, vendor name, vendor location in coordinates, vendor address, rating of vendor by other users, quantity stocked by the vendor and an estimated time to delivery to the user's location or nominated delivery location. The results may be filtered for certain values, so that, for instance, only vendors selling at a price below a user-set value are returned in the response.

In other embodiments, one or more vendors in the vendor lists received by the mobile phone may be highlighted or flashing or otherwise distinguished from the other vendors listed, indicating to the user the availability of special offers or terms by the vendor. By selecting the relevant vendor or icon associated with the vendor, the user will be able to determine the nature of the special offer by the vendor.

Once the user has selected the desired vendor from the vendor list, the user can then order one or more of the product. At step 410, the mobile phone receives the product order from the user and the system proceeds to the ordering stage.

In alternative embodiments, the user is able to repeat the process to select multiple items before proceeding to the ordering stage. This may be particularly beneficial where the multiple items are from the same vendor, and these may be combined to reduce shipping costs. “Shopping baskets”, “carts” or the like may be used for this purpose, as would be apparent to those in the art. Where items are from several vendors, several shopping baskets, each related to a different vendor, may be used.

### Ordering and Paying for the Product

Turning now to FIG. 5, there is shown a preferred method for ordering and paying for the product.

At step 502, the mobile phone receives order instructions. This step may be the same as step 410 shown in FIG. 4.

At step 504, the mobile phone receives payment instructions. Payment instructions will typically include a selection of a method of payment, such as credit card, MPCs or other shopping credits or bank account transfers and information about where payment should be directed.

Shopping credits will typically be in the form of pre-purchased credits linked to the registered mobile phone number.

In some embodiments, the payment instructions may also include paying some amount to an operator of one of previous systems. This may be a flat rate, or may be an amount relative to the price paid for the product.

At step 506, the payment instructions are sent to an order processing and payment server. The order processing and payment server is described in further detail below. After processing the payment, the order processing and payment server may send a payment confirmation to the mobile phone and a payment confirmation and order instructions to the vendor.

In some embodiments there may be an additional payment authorisation step providing additional authentication and payment security. For purchases over a pre-determined value, or a user-set value, the authentication server may automatically send a communication, such as a text message to the mobile phone number of the user requiring an affirmative response prior to the commitment of funds over the indicated value. Alternatively the communication may include a system-generated code that the user needs to enter to release the payment.

At step 508, the mobile phone receives the payment confirmation, and may display this to the user.

At step 510, the mobile phone may receive shipping confirmation from the vendor.

### Payment

There are a number of options as to how the order processing and payment server arranges payment. These options may be presented to the user in the payment instructions, and may be restricted by the vendor.

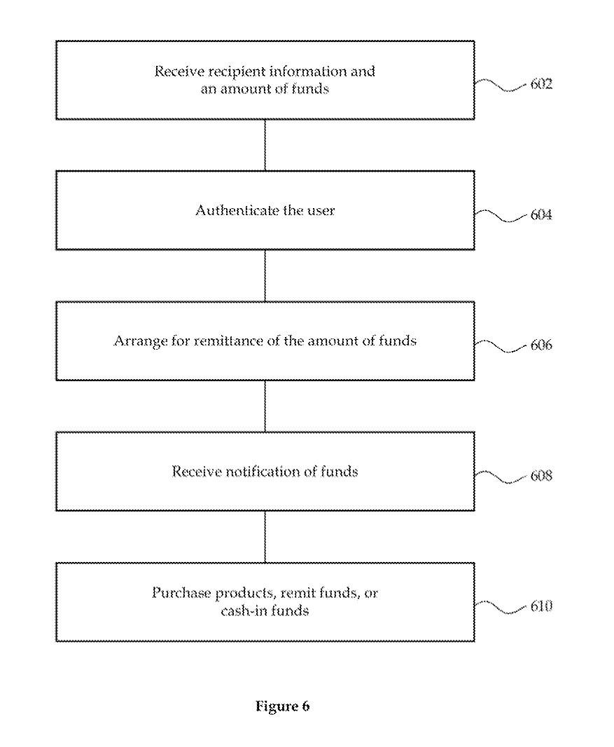

As will be clear to those skilled in the art, the order processing and payment server may include credit card processing, or instruct a remote system, such as that at a bank or the like, to transfer payment using conventional means. Alternatively or additionally, the order processing and payment server may make use of a novel mobile remittance system as described below in relation to FIG. 6. More particularly, an account of credits held against the user's phone number may be used to effect payment to the vendor. This mobile remittance system is also referred to as “Mobile Purchasing Credits” or “MPCs”.

### Non-Mobile Access

Although the present invention is particularly targeted towards transactions effected using a mobile phone or some other device having a phone number, there may also be provided a general interface for non-mobile phone devices to use the present invention, preferably accessed via the Internet. In preferred embodiments, this will be limited to functions other than payment or the remitting of funds.

Typically, this will include a different authentication method, due to the lack of unique mobile device identifiers associated with the non-mobile phone device. This may include a conventional username and/or an email address of the user, with a password, or any other suitable means, as would be clear to those skilled in the art.

In preferred embodiments, the system will not allow a user to commit funds from any device other than the device with mobile device identifiers that are linked to the user's mobile phone or phone number and account on user accounts database 222. In such embodiments, the general interface for non-mobile devices is principally for account enquiry and reporting purposes by the user, and for some limited user profile editing.

### Supermarket Shopping

One particular application of the present invention is shopping in stores where customers typically purchase a plurality of items. Here, the user primarily intends to expedite their shopping and payment experience, rather than locate the nearest or cheapest vendor with the item in-stock or obtain information on the item, although all of these functions would remain available to the user for any item they may wish to purchase in the store.

“Store” should therefore be interpreted broadly as including department stores, supermarkets, and the like. “Store” is also used to refer to the operator of the store, as will be clear from context.

Before shopping, a user registers with the store, a group of stores or a third party administering the system. Registration will typically include providing the store with user information, including at least a mobile phone number for a mobile phone associated with the user.

The method will then typically proceed as the user goes through the store identifying items they wish to purchase. This may be achieved by scanning them with a mobile phone and placing them in a basket, cart or the like. Barcode readers and the like for mobile phones are known in the art. The mobile phone will then typically operate as described above in relation to FIG. 4, although only a single item may be displayed to the user, and comparison data may be omitted. Further, as there will typically only be a single vendor (being the store itself), the comparison and selection of vendors may be omitted.

In this application of the system, the product information server and product information database are typically maintained by the store or a head office thereof, and may be accessed through a wireless network accessible only within the store (or a wider network if required) requiring authentication before a user may access it. This may allow certain people, such as those who have previously shoplifted, to be denied access. The authentication may not require any action by the registered user other than to connect to the wireless network which would then identify the mobile phone of the user as an authorised access device.

Once the user has finished shopping, they can then pay for the items previously identified, substantially in line with the method described above in relation to FIG. 5, with the exception that there is no shipping.

Once purchased, the order information will be received by the store. An agent of the store may review this information, and intervene if it appears the user has been fraudulent in paying for their selected items.

The store may also include a number of gates through which a user must pass before exit. These gates may be configured to scan the items in the user's basket, cast of the like to determine whether the user has paid for the items in full. Systems adapted to scan a bulk of inhomogeneous items are known in the art, for example those using RFID tags on the items, and an RFID scanner at the gate. Other checks are also known in the art such as a weight of the items purchased.

### Remittance

A further aspect of the invention is shown in FIG. 6. There is shown a method for arranging remittance or transfer of funds, which may include shopping credits and the like (namely the MPCs of embodiments of the invention) using registered and authenticated mobile phones between a registered and authenticated remitter in one country and a registered and authenticated recipient in another country or the same country, including via a remittance operator or controller. More particularly, remittance may be made between a remitter account linked to a mobile phone of the remitter and a recipient account which may similarly be linked to a mobile phone of the recipient. It will be appreciated that the same account may be used for both remitting and receiving, as well as for other purposes such as the ordering and payment of products.

At step 602, the remittance operator receives recipient identification information and an indication of the amount of funds from the remitter. Recipient identification information may typically include a mobile phone number, but may also include a name, an address, a code or the like. The amount of funds will generally be denominated in the local currency of the remitter.

At step 604, the remitter is authenticated. Substantially the same authentication procedure to that described in relation to FIG. 3 above may be used.

At step 606, the funds are transferred from the remitter account to the recipient account. The remittance operator may notify the remitter and/or the recipient once the transfer has been completed. The amount of funds received will generally be denominated in the local currency of the recipient.

The remittance operator may charge a fee for arranging the remittance. This may be in the form of a flat fee for each transfer, or may vary in relation to the amount to be transferred. Such a fee may be deducted from the remittance by the system. Equally any fees payable within particular jurisdictions in respect of remittances, and international remittances in particular, may be deducted from the remittance by the system and transferred to the account of the relevant agency. Such an agency account may be in the form of a vendor account as described in relation to vendor accounts database 224.

At step 608, the recipient receives notification from the system of funds remitted and available on their mobile phone.

At step 610, the recipient may apply the funds remitted by purchasing products using the system from step 302, and/or they may in turn remit funds to another user, and/or they may cash in some or all of the funds remitted by arranging for a bank transfer to a conventional bank account, typically in their own country and own currency nominated on their user account.

### Registering

Although not shown in a figure, the operator may require that any user, whether a purchaser, remitter or recipient, be registered prior to using the systems of the operator. Registration will typically be effected via a mobile device and will typically include supplying the operator with the mobile phone number and at least all or some or parts of the automatically extractable device identifiers encoded in or with the mobile device and, when extractable, may include the phone number associated with the the mobile device of the user but may also include a name, an address, a date of birth, passport page image, or the like. This information is then stored in an authentication database.

In preferred remittance embodiments, both the remitter and the recipient would need to be registered on the system, and would have user accounts linked to their mobile phone numbers. In such embodiments, remittances can only be made from the registered mobile phone of the registered remitter or user and receipts can only be spent or cashed-in from the registered mobile phone of the registered recipient or user.

The foregoing description of the invention includes preferred forms thereof. It will be appreciated that modifications may be made to the preferred forms without departing from the spirit and scope of the invention.

The entire disclosures of all applications, patents and publications, cited above and below, if any, are hereby incorporated by reference.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

1. A method for enabling an authenticated user to purchase a product or information using only a registered mobile device, the mobile device being assigned a derived unique identifier which has the user's phone number associated therewith, the method including:
receiving identification information for a product;
sending at least part of the identification information to a product information server;
receiving product information about the product from the product information server;
displaying the product information to the user;
receiving an indication from the user that they wish to purchase the product; and
arranging for payment to be transferred to a vendor associated with the product using pre-purchased credits or other payment methods, the arranging for payment including:
authenticating the user with an authentication server by transmitting authentication information to the authentication server, the authentication information including a device identifier encoded in or with the mobile device.

2. The method of claim 1, wherein the authentication information includes a location, such as coordinates, of the user.

3. The method of claim 1, including, after displaying the product information to the user, receiving product confirmation from the user.

4. The method of claim 1, including, before receiving an indication from the user that they wish to purchase the product, receiving product and/or vendor and/or producer and/or other participant in the product's supply chain information from the product information server, such information costing pre-purchased credits or being free to the user, depending on the information.

5. The method of any claim 4, wherein the vendor information includes one or more of:
location of the vendor;
distance from the user;
distance from a location specified by the user;
the quantity of the product stocked by the vendor;
consumer agency or standards agency labels or certificates given to the product and/or the producer/brand owner, and/or the supply chain of the product;
user ratings of the vendor.

6. The method of claim 1, wherein the authentication information includes a phone number of or associated with the mobile device.

7. The method claim 1, including, prior to authenticating the user, registering the user with an authentication server.

8. The method of claim 7, wherein registering the user includes:
receiving user information, the user information including at least a PIN and/or a password and a phone number associated with the mobile device.

9. The method of claim 1, wherein authentication information includes a PIN and/or a password.

10. The method of claim 7, comprising opening an account with the service provider using only the user's mobile device, providing and authenticating mobile phone number, and automatically extracting the device codes encoded in or with the mobile device
creating a near-unique device identifier from a combination of all or some or parts of the automatically extractable device identifiers encoded in or with the mobile device and, when extractable, a phone number associated with the mobile device of the extractable device codes encoded in or with the mobile device and linking that to the user's mobile phone number
funding the user account with pre-purchased credits through bank transfer, or credit/debit card payment, to the service provider

11. The method of claim 1, wherein the arranging for payment includes:
locally authenticating a user using locally-verified authentication information.

12. The method of claim 11, wherein locally authenticating includes:
receiving an input from the user;
comparing the input with locally-stored reference authentication information;
authenticating the user if the input and the reference authentication information are sufficiently similar.

13. The method of claim 11, wherein the locally-verified authentication information includes biometric information.

14. The method of claim 1, wherein identification information includes one or more of:
a unique or near-unique product code;
the brand of the product;
the name of the product;
the name of the manufacturer;
a model number;
size;
colour;
voltage;
quantity.

15. The method of claim 1, wherein receiving identification information includes one or more of:
reading a barcode;
reading a QR code or the like;
reading an RFID tag;
receiving an image of a product or part thereof.

16. The method of claim 1, wherein the product and/or vendor information includes one or more of:
the vendor;
location of the vendor;
distance from the user;
distance from a location specified by the user;
the quantity of the product stocked by the vendor;
price excluding any tax;
price including applicable taxes;
total price including delivery cost;
delivery cost;
estimated time to delivery;
consumer agency or standards agency labels or certificates given to the product and/or the producer/brand owner, and/or the supply chain of the product;
third party reviews and ratings of the product;
user ratings of the product;
user ratings of the vendor;
ingredients of the product;
nutritional values of the product;
specification of the product.

17. The method of claim 16, wherein any prices are shown in the local currency of the user.

18. The method claim 1, wherein payment is arranged through one or more of:
credit card;
pre-purchased credits;
bank transfer.

19. The method of claim 18, wherein the pre-purchased credits are denominated in the currency of the user and/or are linked to the mobile phone number of the user.

20. A method of authenticating a user of a mobile device used during purchasing, the method including:
receiving authentication information from a mobile device, the authentication information including at least a device identifier encoded in or with the mobile device and, when extractable, a phone number associated with the mobile device and security information;
retrieving a user profile from an authentication database, the user profile corresponding to the phone number;
verifying the security information against the user profile;
notifying the mobile device of whether authentication was successful and/or unsuccessful.

21. The method of claim 20, wherein the phone number includes a country code.

22. A method of remitting pre-paid purchasing credits internationally or domestically between a remitter account linked to a mobile device of a registered and authenticated remitter in one country and a registered and authenticated recipient account linked to a mobile device of a recipient in another country or in the same country, the authenticated remitter using only the registered mobile device of the remitter and the authenticated recipient using only the registered mobile device of the recipient, the method including:
receiving recipient identification information and an indication of an amount of funds from the remitter;
arranging for the sum to be transferred from the remitter account to the recipient account;
wherein the arranging includes:
authenticating the remitter with an authentication server by transmitting authentication information to the authentication server, the authentication information including at least an automatically extractable device identifier encoded in or with the mobile device and, when extractable, a phone number associated with the mobile device, and security information.

23. The method of claim 22, wherein, prior to the receiving recipient information, the method includes:
registering the remitter and/or the recipient, wherein the registering includes:
receiving user information from the remitter and/or the recipient, the user information including at least a phone number associated with the mobile device of the remitter and/or the mobile device of the recipient and/or all or some parts of automatically extractable device identifiers encoded in or with the mobile device of the remitter and/or the recipient;
recording the user information in an authentication database.
